(19) United States
(12) Patent Application Publication
(10) Pub. No.: US 2026/0148372 A1
(43) Pub. Date: May 28, 2026

(54) IMAGE INSPECTION APPARATUS, IMAGE INSPECTION METHOD, AND STORAGE MEDIUM

(71) Applicant: Konica Minolta, Inc., Tokyo (JP)

(72) Inventor: Yoshihiro Esumi, Tokyo (JP)

(73) Assignee: Konica Minolta, Inc., Tokyo (JP)

(21) Appl. No.: 19/397,021

(22) Filed: Nov. 21, 2025

(30) Foreign Application Priority Data
Nov. 25, 2024 (JP) 2024-204806

(51) Int. Cl. G06T 7/00; G06T 3/40; G06T 7/13; G06T 7/90; H04N 1/00; H04N 1/62

(52) U.S. Cl. CPC G06T 7/001; G06T 3/40; G06T 7/13; G06T 7/90; H04N 1/00803; H04N 1/62; G06T 2207/10024; G06T 2207/20016; G06T 2207/30144; G06T 2207/30168

(57) ABSTRACT

An image inspection apparatus including a hardware processor that detects, based on a reference image, presence or absence of an abnormality in a read image generated by reading, by a reader, a recording medium on which an image is formed. The hardware processor detects a color material drop in the read image.

### CROSS-REFERENCE TO RELATED APPLICATIONS

The entire disclosure of Japanese Patent Application No. 2024-204806 filed on Nov. 25, 2024 is incorporated herein by reference in its entirety.

### BACKGROUND OF THE INVENTION

### Technical Field

The present disclosure relates to an image inspection apparatus, an image inspection method, and a storage medium.

### Description of Related Art

Conventionally, an image inspection apparatus is known that can detect a stain on a sheet. A typical image inspection apparatus detects stains on a sheet by comparing a reference image registered in advance with an inspection image formed on the sheet. In a case where the reference image is obtained by reading an image formed on a sheet, it is possible to detect the stain on the sheet by performing threshold value processing on a difference image between the reference image and the inspection image. On the other hand, in a case where the reference image is RIP data (RIP image), since the color (whiteness) of the sheet on which the inspection image is printed is not accurately known, threshold value processing cannot be performed on a simple difference image between the reference image and the inspection image. This is because when the difference between the RIP image and the inspection image is obtained, the difference value of a stainy portion appearing in the difference image may become large because the paper color is unknown. In this case, even if the difference value exceeds a certain threshold value by simple threshold value processing, it cannot be determined that there is stain. Therefore, the stain on the sheet cannot be accurately detected.

Therefore, Japanese Unexamined Patent Publication No. 2019-158757 discloses a configuration in which stain detection is performed by performing stain edge detection on a difference image using a filter. Japanese Unexamined Patent Publication No. 2019-158757 According to the configuration described in the publication, stain detection can be achieved without using a difference value between the RIP image and the inspection image.

### SUMMARY OF THE INVENTION

However, the configuration described in Japanese Unexamined Patent Publication No. 2019-158757 can only detect stain of a size and shape that reacts to the edge detection filter. Therefore, there is a problem that the stain which is large in size and of which an end portion is in the form of a gradation, such as a drop of color material (toner), is difficult to detect an edge and is difficult to perform detection.

An object of the present disclosure is to provide an image inspection apparatus, an image inspection method, and a storage medium capable of detection of a large stain such as a color material drop.

To achieve at least one of the abovementioned objects, according to an aspect of the present invention, image inspection apparatus reflecting one aspect of the present invention comprises:
a hardware processor that detects, based on a reference image, presence or absence of an abnormality in a read image generated by reading, by a reader, a recording medium on which an image is formed, wherein
the hardware processor detects a color material drop in the read image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of an image inspection system according to the present embodiment;

FIG. 2 is a functional block diagram illustrating a control structure of the image inspection system according to the present embodiment;

FIG. 3 is a flowchart illustrating an example of abnormality detection control for detecting the color material drop;

FIG. 4 is a diagram illustrating an example of a state in which the resolutions of the reference image and the inspection image are reduced;

FIG. 5 is a diagram illustrating an example of luminance value in a resolution-reduced RIP image and an inspection image;

FIG. 6 is a diagram illustrating a difference between a luminance value in the RIP image and a luminance value in the inspection image;

FIG. 7 is a diagram illustrating an example of a difference image;

FIG. 8 is a flowchart illustrating a modification example of abnormality detection control for detecting the color material drop;

FIG. 9 is a diagram illustrating an example of a difference image in which an edge is detected; and

FIG. 10 is a flowchart illustrating an example of abnormality detection control for detecting minute stain.

### DETAILED DESCRIPTION

Hereinafter, one or more embodiments of the present invention will be described with reference to the drawings. However, the scope of the invention is not limited to the disclosed embodiments.

Hereinafter, embodiment of the present disclosure will be described in detail with reference to the drawings.

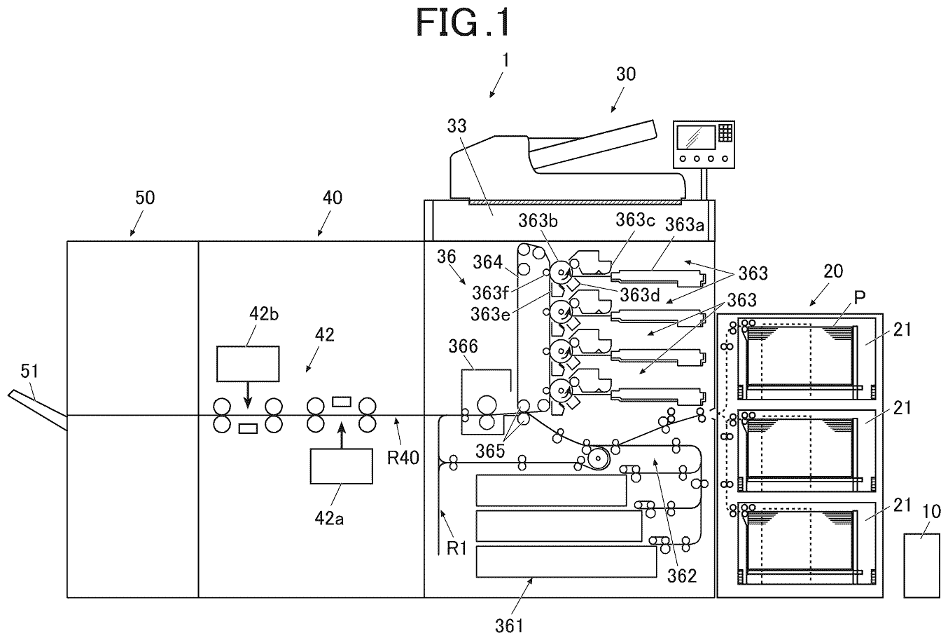

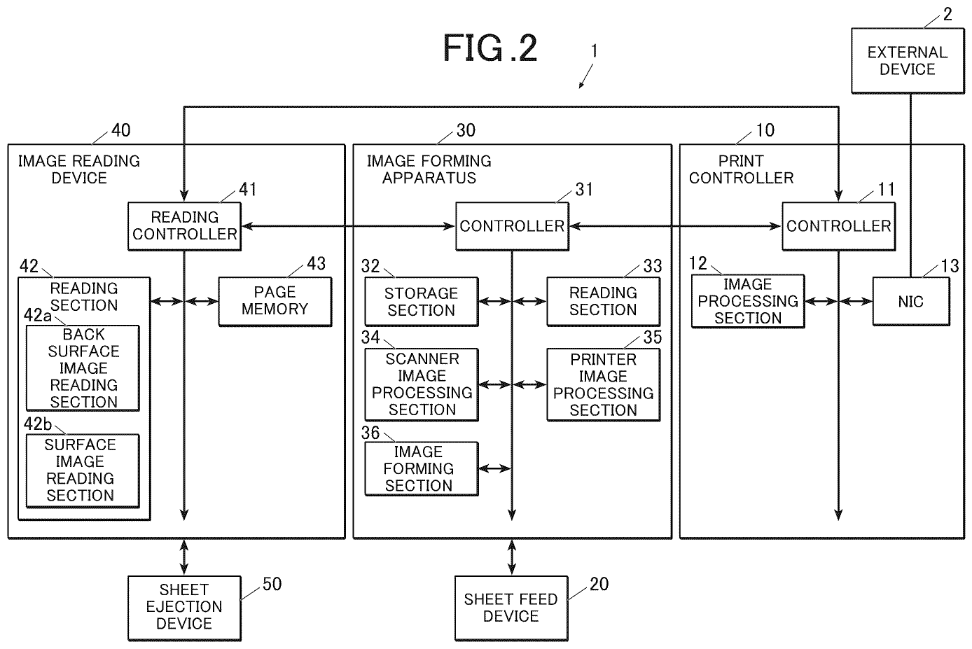

As shown in FIGS. 1 and 2, the image inspection system 1 according to the present embodiment includes a print controller 10, a sheet feed device 20, an image forming apparatus 30, an image reading device (image inspection apparatus) 40, and a sheet ejection device 50. The image inspection system 1 is connected to an external device 2 such as a personal computer via NIC 13 of a print controller 10 so as to be able to transmit and receive information to and from the external device 2.

When the image forming apparatus 30 is used as a network printer, the print controller 10 manages and controls image data. The image data is input to the image forming apparatus 30 from the external device 2 connected to a LAN. The print controller 10 receives image data to be printed from the external device 2 and transmits the received image data to the image forming apparatus 30.

The print controller 10 includes a controller 11, an image processing section 12, and a NIC 13.

The controller 11 includes a CPU, a ROM, and a RAM and comprehensively controls the operation of each component of the print controller 10. The controller 11 outputs the image data input from the external device 2 to the image forming apparatus 30 via the NIC 13.

The image processing section 12 performs rasterization (RIP) processing on the image data input from the external device 2 to generate image data (RIP image data) of each color of CMYK.

The NIC 13 is a communication interface that receives the image data to be printed from the external device 2 via the LAN.

The sheet feed device 20 includes a plurality of sheet feed trays 21 and a sheet feed means (not illustrated), and feeds a sheet (recording medium) P stored in a sheet feed tray 21 to the image forming apparatus 30. The sheet feed means includes, for example, a sheet feed roller, a separation roller, a sheet feed/separation rubber, a feed-out roller and the like. Each of the sheet feed trays 21 stores a sheet P for each type of the sheet P (paper type, basis weight, sheet size, and the like). The sheet feed device 20 conveys sheets P one by one from the top of the sheets P stored in each sheet feed tray 21 to the image forming apparatus 30.

The image forming apparatus 30 is a multifunction apparatus that forms an image on a sheet based on image data read from a document or image data received from the external device 2 via the LAN. The image forming apparatus 30 includes a controller 31, a storage section 32, a reading section 33, a scanner image processing section 34, a printer image processing section 35, and an image forming section 36.

The controller 31 includes a CPU, a RAM, a ROM, and the like. First, the CPU reads various program stored in the ROM and develops the program in the RAM. Next, the CPU comprehensively controls the operation of each component of the image forming apparatus 30 in cooperation with the various programs developed in the RAM.

The storage section 32 stores programs readable by the controller 31, files for executing the programs, and the like. The storage section 32 includes, for example, a large-capacity memory such as a hard disk.

The reading section 33 includes an automatic document feeder, a scanner and the like and reads a document surface set on a document plate to generate image data. Each pixel of the image data generated by the reading section 33 has three color pixel values of red (R), green (G), and blue (B) and is color-converted into image data having four color pixel values of C, M, Y, and K.

The scanner image processing section 34 performs various kinds of processing on the analog image data input from the reading section 33 and then generates digital image data. The various kinds of processing include analog processing, A/D conversion processing, shading processing, and the like. The generated image data is output to the printer image processing section 35.

The printer image processing section 35 generates print image data based on the image data input from the scanner image processing section 34 or the image processing section 12 of the print controller 10. The print image data is image data for image formation. The print image data generated by the printer image processing section 35 is output to the image forming section 36.

The image forming section 36 performs image formation processing using an electrophotographic method. The image forming section 36 forms an image of four colors of C, M, Y, and K on a sheet, according to the pixel values of the four colors of each pixel of the print image data.

The image forming section 36 includes a sheet feed section 361, a conveyance section 362, four writing units 363, an intermediate transfer belt 364, a transfer section 365, and a fixing section 366.

The sheet feed section 361 includes a plurality of sheet feed trays and a sheet feed means (not illustrated). The sheet feed means includes, for example, a sheet feed roller, a separation roller, a sheet feed/separation rubber, a feed-out roller and the like. Each sheet feed tray stores sheets for each type of sheet (paper type, basis weight, sheet size, and the like). The sheet feed section 361 conveys sheets one by one from the top of the sheets stored in each sheet feed tray to the conveyance section 362.

The conveyance section 362 conveys the sheet conveyed from the sheet feed section 361 to a secondary transfer position of the image forming section 36 via a sheet conveyance route to the transfer section 365.

Four writing units 363 are arranged in series (tandem) along the belt plane of the intermediate transfer belt 364 to form images in C, M, Y and K colors. The writing units 363 have the same configuration except that they form images of different colors. Each writing unit 363 includes an exposure section 363a, a photosensitive drum 363b, a developing section 363c, a charging section 363d, a cleaning section 363e, and a primary transfer roller 363f.

In image formation, first, each of the writing units 363 causes the charging section 363d to charge the photosensitive drum 363b. Next, the writing unit 363 scans the photosensitive drum 363b with a light flux emitted from the exposure section 363a based on the image data, thereby forming an electrostatic latent image. Next, the writing unit 363 causes the developing section 363c to supply toner to develop the image. Thus, an image (monochromatic toner image) is formed on the photosensitive drum 363b.

Next, each of the writing units 363 causes the primary transfer roller 363f to primarily transfer the image formed on each of the photosensitive drums 363b onto the intermediate transfer belt 364 in a sequentially superimposed manner. Thus, an image of the four colors (toner image) is formed on the intermediate transfer belt 364. Next, each of the writing units 363 causes the cleaning section 363e to remove the toner remaining on the photosensitive drum 363b.

Next, the image forming section 36 causes the sheet feed device 20 or the sheet feed section 361 to feed a sheet at a time when the image on the rotating intermediate transfer belt 364 reaches the position of the transfer section 365. Next, the image forming section 36 causes the transfer section 365 to secondarily transfer the image (color toner image) from the intermediate transfer belt 364 onto a sheet. Next, the image forming section 36 conveys the sheet to the fixing section 366 and causes the fixing section 366 to perform fixing processing. In the fixing processing, the sheet is heated and pressurized by the fixing section 366 to fix the image onto the sheet. When images are to be formed on both sides of the sheet, the image forming section 36 conveys the sheet to a reversing path R1 to reverse the sheet and then conveys the sheet again to the position of the transfer section 365.

The image reading device 40 is disposed downstream of the image forming apparatus 30. The image reading device 40 includes a controller (controller) 41 (hardware processor), a reading section 42, and a page memory 43.

The reading controller 41 performs various kinds of processing on analog image data input from the reading section 42 and then generates RGB digital image data. The various kinds of processing include, for example, analog processing, A/D conversion processing, shading correction processing, color conversion processing, scaling processing, and the like. The generated image data is output to the page memory 43.

Further, the reading controller 41 detects the presence or absence of abnormality in the read image (inspection image) generated by the reading section 42 (reader) reading the sheet on which the image is formed, based on the reference image. As a result, it is possible to detect adhesion of the stain and detection of erroneous printing.

The reading section 42 scans both sides of a sheet on which images have been formed by the image forming section 36, and optically reads the images on both sides of the sheet. The reading section 42 includes a back surface image reading section 42a and a surface image reading section 42b.

The back surface image reading section 42a is provided below the conveyance route R40, and reads an image formed on the back surface of the sheet. The surface image reading section 42b is provided above the conveyance route R40, and reads an image formed on the surface of the sheet. The surface image reading section 42b is provided on the downstream side in the conveyance direction of the sheet with respect to the back surface image reading section 42a. The back surface image reading section 42a and the surface image reading section 42b are arranged at mutually different positions at a distance in the conveyance direction of the sheet. Thus, both sides of the sheet can be read in one pass. The reading results (analog image data) read by the back surface image reading section 42a and the surface image reading section 42b are output to the reading controller 41.

The page memory 43 includes, for example, a DRAM and stores the image data generated by the reading controller 41.

The sheet ejection device 50 is disposed at a subsequent stage of the image reading device 40, and discharges a sheet from which an image has been read by the image reading device 40 to the sheet ejection tray 51.

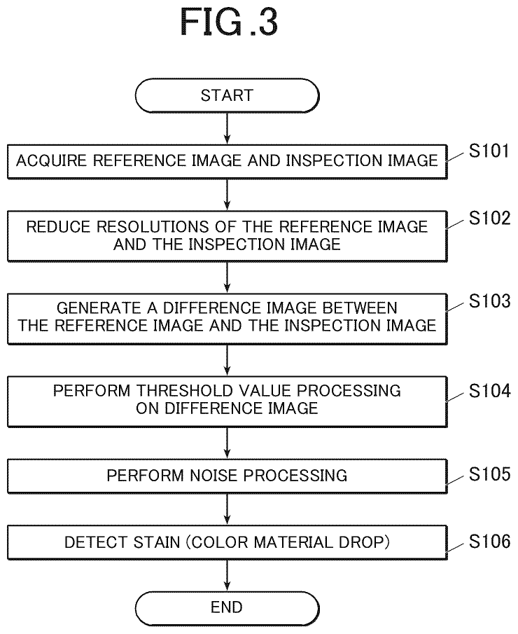

Next, control of the image inspection system 1 according to the present embodiment will be described with reference to the flowchart of FIGS. 3, 8, and 10.

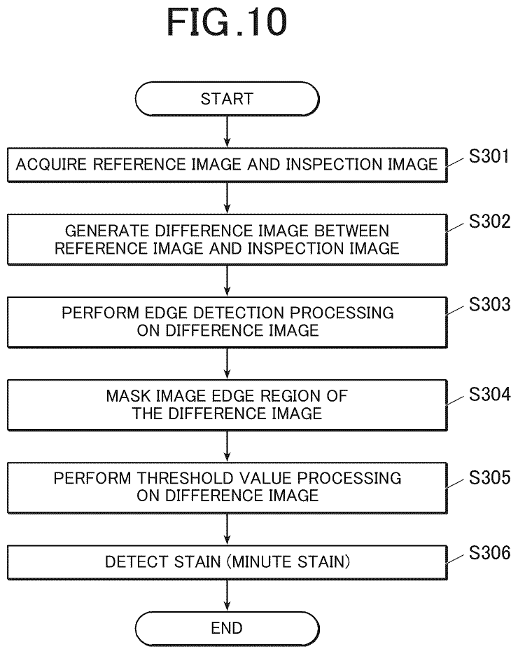

FIG. 3 is a flowchart illustrating an example of abnormality detection control for detecting a color material drop (the stain in which the size is large and the end portion has a gradation shape). The color material in the the color material drop includes any one of toner and ink. The control of FIG. 3 is a second inspection of the present disclosure for detection of the color material drop in the read image. The second inspection is different from the first inspection (refer to FIG. 10) of the present disclosure in which minute stain in a read image is detected.

First, the reading controller 41 of the image reading device 40 acquires a reference image and an inspection image (step S101). In the present embodiment, the reference image is an RIP image. The RIP image is an image for printing after the RIP processing. The reference image is stored, for example, in the storage section 32 of the image forming apparatus 30. The inspection image is a read image generated by reading, by the reading section 42, a sheet (printed material) on which an image is formed.

Next, the reading controller 41 reduces the resolutions of the reference image and the inspection image acquired in step S101 (step S102). Thus, since the region occupied by one pixel is increased, it is possible to make it easier to perform detection of large stain such as the color material drop. In addition, the processing can be simplified and speeded up.

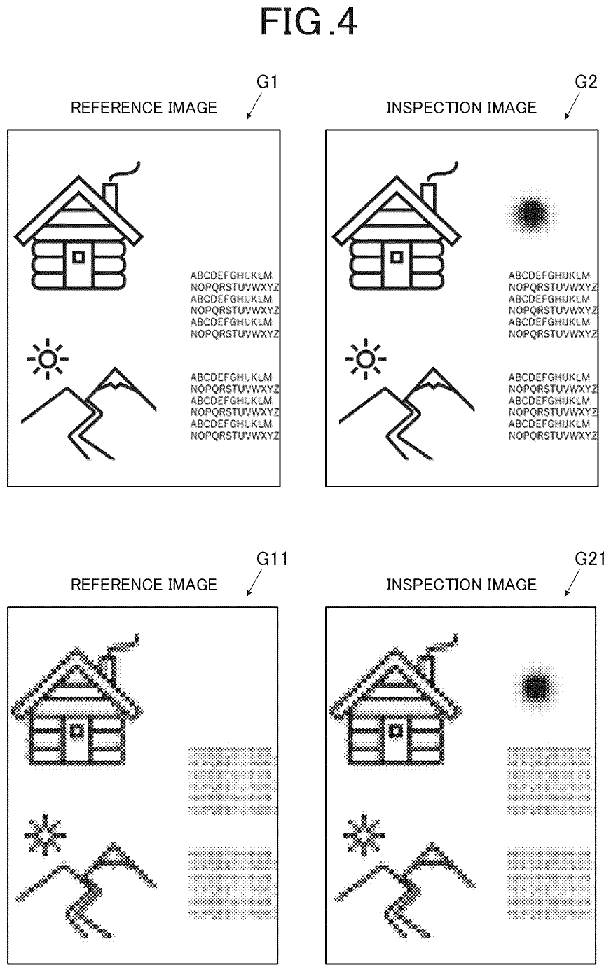

FIG. 4 shows an example of a state in which the resolutions of the reference image and the inspection image are reduced. The symbol G1 in FIG. 4 is an example of the reference image. Reference numeral G2 in FIG. 4 is an example of an inspection image. Reference sign G11 in FIG. 4 is an example of the low-resolution reference image. The reference sign G21 in FIG. 4 is an example of a low-resolution inspection image.

Next, the reading controller 41 generates a difference image between the reference image and the inspection image whose resolutions have been reduced in step S102 (step S103). The difference image is generated by calculating a difference between pixel values (luminance values) of the respective pixels. Note that in order to eliminate the influence of the paper color of the inspection image, the reading controller 41 generates the difference image such that the difference value of the paper white region becomes zero.

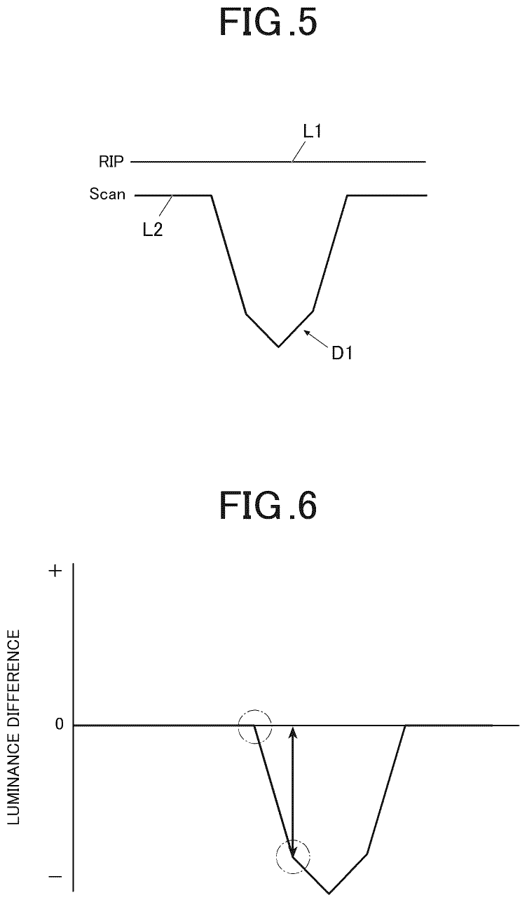

FIG. 5 illustrates an example of luminance value in the RIP image and the inspection image whose resolutions have been reduced. A symbol L1 in FIG. 5 is an example of the luminance value in the low-resolution RIP image. A code L2 in FIG. 5 is an example of a luminance value in the inspection image whose resolution has been reduced. A spot (reference sign D1) protruding downward at the luminance value L2 in the inspection image indicates that the inspection image is contaminated (has stain(s)).

FIG. 6 illustrates the difference (brightness difference) between the luminance value L1 in the RIP image and the luminance value L2 in the inspection image. In the example illustrated in FIG. 6, as a result of excluding the influence of the paper color of the inspection image, it can be seen that the difference value of the region having no stain in the paper white region is 0.

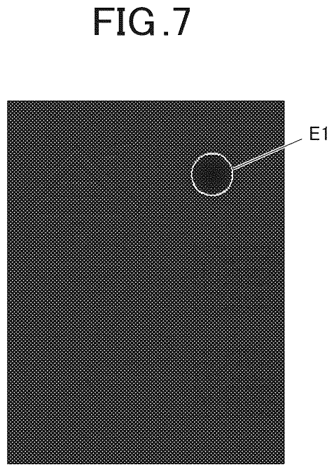

FIG. 7 shows an example of the difference image. In the example illustrated in FIG. 7, it is found that the stainy region E1 is darker than the other regions.

Next, the reading controller 41 performs threshold value processing on the paper white region of the difference image generated in step S103 (step S104). The threshold value processing is bInarization processing using a predetermined threshold value. The reading controller 41 extracts, from among the pixels of the paper white region in the difference image, pixels whose pixel values (luminance values) exceed a predetermined threshold value.

Next, the reading controller 41 performs noise processing on the threshold value processed difference image (step S105). As a result, it is possible to remove the stain having a size of about several dots as noise, and thus it is possible to suppress erroneous detection of the stain.

Next, the reading controller 41 detects that the pixel extracted by the threshold value processing has the stain (the color material drop) (step S106). Thus, the reading controller 41 can perform detection of the color material drop in the read image.

As described above, the reading controller 41 reduces the resolution of the reference image and the read image, and performs detection of the color material drop based on the reference image and the read image of which the resolution is reduced. Specifically, the reading controller 41 detects the color material drop on the basis of the luminance value in the difference image (difference image) between the reference image and the read image whose resolutions have been reduced. More specifically, the reading controller 41 detects the color material drop on the basis of the luminance value of the paper white region in the difference between the reference image and the read image whose resolutions have been reduced.

For the paper white region, the luminance value in the RIP image and the luminance value in the inspection image can be matched (the luminance difference can be set to 0), and thus the threshold value processing can be performed. On the other hand, since the halftone region is influenced by the paper color (the whiteness of the paper) of the inspection image, the luminance value in the RIP image and the luminance value in the inspection image cannot be matched. Therefore, the control (threshold value processing) shown in FIG. 3 cannot be performed on the halftone region as it is.

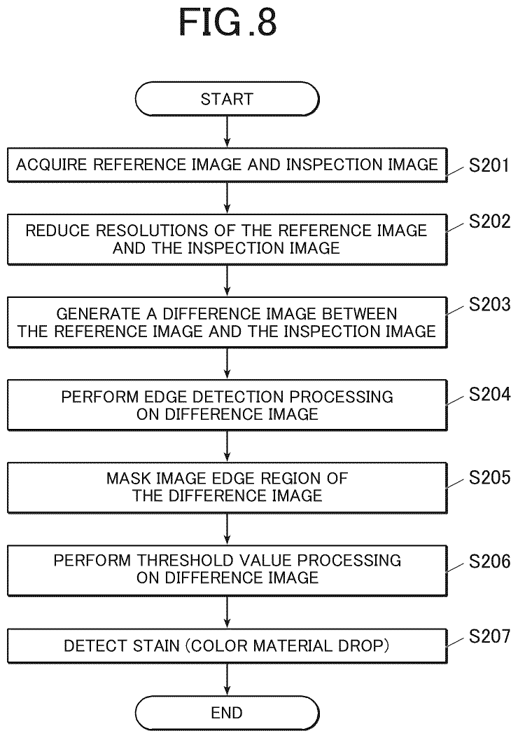

FIG. 8 is a flowchart illustrating a modification example of the abnormality detection control for detecting the color material drop. The detection illustrated in FIG. 8 detects the color material drop in a halftone region.

Since the processes of step S201 and step S202 are the same as the processes of step S101 and step S102 of FIG. 3, the description will be omitted.

Next, the reading controller 41 generates a difference image between the reference image and the inspection image (step S203). The difference image is generated by calculating a difference between pixel values (luminance values) of the respective pixels. Note that in order to eliminate the influence of the paper color of the inspection image, the reading controller 41 generates the difference image such that the difference value of the paper white region becomes zero.

Next, the reading controller 41 performs a process of detecting an edge (edge detection process) on the halftone region of the difference image generated in step S203 (step S204). The edge is a portion where a variation in pixel value (luminance value) is large compared to an adjacent pixel in the difference image. Specifically, the reading controller 41 performs a process of applying an edge detection filter to the difference image. By this processing, it is possible to emphasize a portion (edge) having a large variation in value between pixels in the difference image. As the edge detection filter, for example, a Sobel filter, a Robinson filter, or the like can be used.

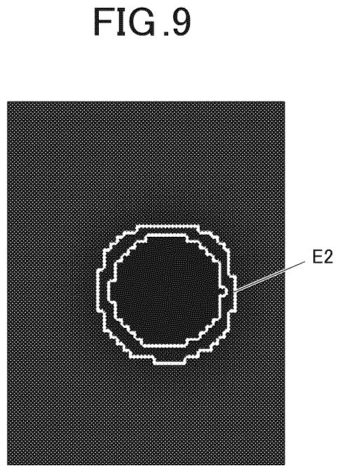

FIG. 9 shows an example of a difference image in which an edge is detected. Reference numeral E2 in FIG. 9 is an example of the detected edge region.

Next, the reading controller 41 masks the image edge region of the difference image subjected to the edge detection processing in step S204 (step S205). Specifically, the reading controller 41 extracts edge information of an image region from the RIP image in advance, and excludes the image edge region from inspection targets. Since an edge portion of an image has a large gradation fluctuation, a large difference occurs due to a misregistration, which causes erroneous detection. In the process of step S205, since the image edge region can be excluded from the inspection target, it is possible to suppress erroneous detection.

Next, the reading controller 41 performs threshold value processing on the difference image on which the edge detection processing has been performed in step S204 (step S206).

Next, the reading controller 41 detects that the pixel extracted by the threshold value processing has the stain (the color material drop) (step S207). Accordingly, the reading controller 41 can detect the color material detection in the read image even in the halftone region.

As described above, the reading controller 41 detects an edge in the difference between the reference image and the read image whose resolutions have been reduced, and detects the color material drop on the basis of the detection result of the edge. Specifically, the reading controller 41 detects an edge in a halftone region of the difference between the reference image and the read image whose resolutions have been reduced, and detects the color material drop on the basis of the edge detection result.

FIG. 10 is a flowchart illustrating an example of abnormality detection control for detecting minute stain.

First, the reading controller 41 acquires a reference image and an inspection image (step S301).

Next, the reading controller 41 generates a difference image between the reference image and the inspection image (step S302). The difference image is generated by calculating a difference between pixel values (luminance values) of the respective pixels.

Next, the reading controller 41 performs a process of detecting an edge (edge detection process) on the difference image generated in step S302 (step S303). Specifically, the reading controller 41 performs a process of applying a filter to the difference image. The edge detection filter is a filter for detecting an edge.

Next, the reading controller 41 masks an image edge region of the difference image (step S304).

Next, the reading controller 41 performs threshold value processing on the difference image (step S305).

Next, the reading controller 41 detects that there is the stain (minute stain) in the pixels extracted by the threshold value process (step S306). As a result, the reading controller 41 can perform detection of minute stain in the read image.

As described above, the reading controller 41 further detects an edge in the difference between the reference image and the read image, and detects (minute) stain in the read image based on the detection result of the edge.

As described above, the image inspection apparatus (image reading device 40) according to the present embodiment includes a controller (reading controller 41) that detects, based on a reference image, the presence or absence of an abnormality in a read image generated by a reading section 42 reading a recording medium on which an image is formed. The controller detects the color material drop in the read image.

Therefore, according to the image inspection apparatus of the present embodiment, it is possible to perform detection of a large stain such as a color material drop. Therefore, it is possible to more reliably perform detection of the stain on the recording medium.

Further, the controller detects the stain in the read image in a first inspection, and detects the color material drop in a second inspection different from the first inspection.

Therefore, it is possible to detection not only a large stain such as the color material drop but also a minute stain. Therefore, it is possible to more reliably perform detection pf the stain on the recording medium.

Further, the controller reduces the resolution of the reference image and the read image, and detects the color material drop on the basis of the reference image and the read image reduced in resolution.

Therefore, it is possible to perform detection of a large stain such as the color material drop. Therefore, it is possible to more reliably perform detection of the stain on the recording medium.

The controller also detects the color material drop on the basis of a luminance value in a difference between the reference image and the read image whose resolutions have been reduced. In particular, the controller detects the color material drop based on the luminance value of the paper white region in the difference between the reference image and the read image whose resolutions have been reduced.

Therefore, it is possible to simply detection a large stain such as the color material drop. Therefore, it is possible to more reliably and simply perform detection of the stain on the recording medium.

Furthermore, the controller detects an edge in a difference between the reference image and the read image whose resolutions have been reduced, and detects the color material drop on the basis of a detection result of the edge. In particular, the controller detects an edge in a halftone region of a difference between the reference image and the read image whose resolutions have been reduced, and detects the color material drop based on a detection result of the edge.

Therefore, the color material drop in the halftone region can be detected. Therefore, it is possible to more reliably perform detection of the stain on the recording medium.

The controller further detects an edge in a difference between the reference image and the read image, and detects the stain in the read image on the basis of a detection result of the edge. At this time, the controller detects the edge using a filter for detecting the edge.

Therefore, it is possible to further perform detection of minute stain in the read image. Therefore, it is possible to more reliably perform detection of the stain on the recording medium.

In addition, the color material drop is the stain in which an end portion has a gradation shape. The color material in the color material drop includes any of toner and ink.

Therefore, it is possible to detect a stain (a drop of toner or ink) which is difficult to detect because of difficulty in edge detection. Therefore, it is possible to more reliably perform detection of the stain on the recording medium.

The reference image is a RIP image.

Therefore, even in a case where the color (whiteness) of the sheet on which the inspection image is printed is not accurately known, the color material drop can be detected. Therefore, it is possible to more reliably perform detection of the stain on the recording medium.

Although specific description has been given above based on the embodiment according to the present disclosure, the present disclosure is not limited to the above-described embodiment, and changes can be made without departing from the spirit and scope of the present disclosure.

For example, the color material drop detected in the second inspection may include that on the content included in the read image.

In this case, the color material drop on the content can also be detection. Therefore, it is possible to more reliably perform detection of the stain on the recording medium.

Furthermore, in the above-described embodiment, the configuration in which the image reading device 40 as the image inspection apparatus of the present disclosure includes the reading section 42 has been described as an example, but the configuration is not limited thereto. For example, an apparatus including the reading section 42 may be configured as a separate body, and the image inspection apparatus may be configured to be specialized in the inspection of the read image read by the reading section 42 of the separate body apparatus.

Furthermore, in the above-described embodiment, a configuration in which the electrophotographic method is applied for the image forming section 36 has been described as an example, but it is not limited thereto. For example, instead of the electrophotographic method, another printing method such as an inkjet method or a thermal sublimation method may be applied.

Furthermore, each aspect illustrated in the present application can also be grasped as a method, program, or the like. With respect to the category of the method or the program, “unit” indicated in the category of the apparatus is appropriately replaced with, for example, “step”, “step”, or “means”. Furthermore, the order of the processes or the steps is not limited to the one directly specified in the present application, and the order can be changed, or a part of the processes can be collectively performed or can be performed one by one as needed.

Besides, the detailed configuration of each device constituting the image inspection system and the detailed operation of each device can also be appropriately modified without departing from the spirit and scope of the present disclosure.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection apparatus comprising a hardware processor that detects, based on a reference image, presence or absence of an abnormality in a read image generated by reading, by a reader, a recording medium on which an image is formed, wherein
the hardware processor detects a color material drop in the read image.

2. The image inspection apparatus according to claim 1, wherein the hardware processor detects a stain in the read image in a first inspection, and detects the color material drop in a second inspection different from the first inspection.

3. The image inspection apparatus according to claim 1, wherein the hardware processor reduces resolutions of the reference image and the read image, and detects the color material drop based on the reference image and the read image whose resolutions have been reduced.

4. The image inspection apparatus according to claim 3, wherein the hardware processor detects the color material drop based on a luminance value in a difference between the reference image and the read image whose resolutions have been reduced.

5. The image inspection apparatus according to claim 4, wherein the hardware processor detects the color material drop based on a luminance value of a paper white region in a difference between the reference image and the read image whose resolutions have been reduced.

6. The image inspection apparatus according to claim 3, wherein the hardware processor detects an edge in a difference between the reference image and the read image whose resolutions have been reduced, and detects the color material drop based on a detection result of the edge.

7. The image inspection apparatus according to claim 6, wherein the hardware processor detects an edge in a halftone region of a difference between the reference image and the read image whose resolutions have been reduced, and detects the color material drop based on a detection result of the edge.

8. The image inspection apparatus according to claim 1, wherein the hardware processor further detects an edge in a difference between the reference image and the read image, and detects a stain in the read image based on a detection result of the edge.

9. The image inspection apparatus according to claim 8, wherein the hardware processor detects the edge by using a filter for detecting the edge.

10. The image inspection apparatus according to claim 1, wherein the color material drop is a stain whose end portion has a gradation shape.

11. The image inspection apparatus according to claim 1, wherein a color material in the color material drop includes one of toner and ink.

12. The image inspection apparatus according to claim 1, wherein the color material drop includes a color material drop on a content included in the read image.

13. The image inspection apparatus according to claim 1, wherein the reference image is a RIP image.

14. An image inspection method of an image inspection apparatus, the method comprising controlling that is detecting, based on a reference image, presence or absence of an abnormality in a read image generated by reading, by a reader, a recording medium on which an image is formed, wherein
in the controlling, a color material drop in the read image is detected.

15. A non-transitory computer-readable storage medium storing a program causing a computer of an image inspection apparatus to execute controlling that is detecting, based on a reference image, presence or absence of an abnormality in a read image generated by reading, by a reader, a recording medium on which an image is formed, wherein
in the controlling, a color material drop in the read image is detected.
